(19) United States
(12) Patent Application Publication
(10) Pub. No.: US 2016/0163213 A1
(43) Pub. Date: Jun. 9, 2016

(54) Symbol Image Education Apparatus and Method Therefor

(71) Applicant: Jung Ha RYU, Gyeonggi-do (KR)

(72) Inventor: Jung Ha RYU, Gyeonggi-do (KR)

(21) Appl. No.: 14/903,633

(22) PCT Filed: Jul. 9, 2014
(86) PCT No.: PCT/KR2014/006177

§ 371 Date: Jan. 8, 2016

(30) Foreign Application Priority Data
Jul. 9, 2013 (KR) 10-2013-0080575

(51) Int. Cl. G09B 7/02; G09B 19/00; G09B 5/02

(52) U.S. Cl. CPC G09B 7/02; G09B 5/02; G09B 19/00

(57) ABSTRACT

The present invention relates to a symbol image education apparatus and a method therefor, and more particularly, to a symbol image education method and an apparatus therefor, the symbol image education method including the steps of: outputting a question regarding a symbol image corresponding to a predetermined letter; receiving an answer to the outputted question from a user; determining whether the answer received from the user is the correct answer to the outputted question; and outputting whether the answer received from the user is the correct answer to the outputted question, wherein the symbol image having a predetermined shape is formed in a position corresponding to a margin position of an image of the letter.

### TECHNICAL FIELD

The present invention relates to a symbol image education apparatus and method, and more particularly, to a symbol image education apparatus and method of enhancing public awareness of a symbol image obtained by symbolizing letters such as Hangul, English, numerals and a design object obtained by embodying the symbol image, by motivating general people to learn a symbol image by using games and tests.

### BACKGROUND ART

In modern times, according to an advance in image media, there is a growing importance of an information delivery function of an image, as well as a letter. For example, with regard to refugee and hunger relief, an image combined with letters or numerals may have a greater appeal than that of a lengthy petition letter. In consideration of periodic characteristics, there is a great need for a plan to increase industrial utilization of an image that symbolically implies a language, by further developing the language from a simple information transmission medium.

Particularly, there is an urgent need for a plan to enhance recognition and industrial utilization of a language by symbolically represent a language letter or a numeral in industrial products (products, works of art, structures, craftworks, building, or the like) in various fields such as industry, art, design, architecture, craft, urban planning, or the like. As such, there is a demand for a design solution for easily designing industrial products to which symbol images in which letters of Hangul or English, or numerals are symbolized are applied.

There is also a demand for a game and an education solution for providing symbol image learning by motivating people to learn a symbol image by using games and tests, so as to increasing public awareness of a symbol image obtained by symbolizing letters such as Hangul, English, numerals and a design object obtained by embodying the symbol image.

### DETAILED DESCRIPTION OF THE INVENTION

### Technical Problem

The present invention provides a symbol image education apparatus and method of enhancing public awareness of a symbol image obtained by symbolizing letters such as Hangul, English, numerals and a design object obtained by embodying the symbol image, by motivating people to learn a symbol image by using games and tests.

### Technical Solution

According to an aspect of an exemplary embodiment, a symbol image education method includes: outputting, by a symbol image education apparatus, a question related to a symbol image corresponding to a letter; receiving, by the symbol image education apparatus, an input of an answer to the output question from a user; determining, by the symbol image education apparatus, whether the answer, input from the user, is a correct answer to the output question; and outputting, by the symbol image education apparatus, whether the answer input from the user is correct, wherein the symbol image is formed by at least one representation image having a predetermined shape in a location corresponding to a margin position of an image of the letter.

According to an aspect of an exemplary embodiment, a symbol image education apparatus includes: an output unit configured to output a question related to a symbol image corresponding to a letter; an input unit configured to receive an input of an answer to the output question from a user; an operation unit configured to determine whether the answer, input from the user, is a correct answer to the output question; and a controller configured to output the question, determine whether the answer is correct if the answer by the user is input, and output a result of the determination as to whether the answer is correct, wherein the symbol image is formed by at least one representation image having a predetermined shape in a location corresponding to a margin position of an image of the letter.

With respect to the question, the symbol image may be output and a letter corresponding to the output symbol image may be required, the letter may be output and a symbol image corresponding to the output letter may be required to be input, or the symbol image having an inaccurate form may be output and an accurate form of the output symbol image may be required.

The representation image may include an image of a dot having a certain shape.

The symbol image may include symbol images that correspond to a plurality of letters and overlap with each other in a space.

With respect to the symbol image, representation images of the symbol image may not be output to a screen at a same time, and screens in which a part of the representation images is output may be sequentially output.

The output question may be transmitted from a terminal of another user.

The symbol image education apparatus may further include a storage unit configured to store information about the question and a correct answer to the question.

According to an aspect of an exemplary embodiment, a non-transitory computer-readable recording storage medium having recorded thereon a computer program which, when executed by a computer, may perform the method.

### Advantageous Effects of the Invention

In the present invention, public awareness of a symbol image obtained by symbolizing letters such as Hangul, English, numerals and a design object obtained by embodying the symbol image may be enhanced by motivating people to learn a symbol image by using games and tests.

### DESCRIPTION OF THE DRAWINGS

FIG. 1 is a block diagram showing a configuration of a symbol image editing apparatus in the present invention;

FIG. 2 illustrates a diagram showing a process of symbolizing a Hangul letter and expressing the Hangul letter as a symbol image in the present invention;

FIG. 3 illustrates a diagram showing a process of expressing an English alphabet as a symbol image, in the present invention;

FIGS. 4A through 4S illustrate diagrams showing a principle of generating a symbol image corresponding to an initial consonant of a Hangul letter, according to an exemplary embodiment of the present invention;

FIGS. 5A through 5U illustrate diagrams showing a principle of generating a symbol image corresponding to a vowel of a Hangul letter, according to an exemplary embodiment of the present invention;

FIGS. 6A through 6K illustrate diagrams showing a principle of generating a symbol image corresponding to a final consonant of a Hangul letter according to an exemplary embodiment of the present invention;

FIGS. 7A through 7I illustrate diagrams for explaining a principle of generating a transformed symbol image according to an exemplary embodiment of the invention;

FIGS. 8A through 8F illustrate diagrams for explaining an area in which a symbol image is respectively generated with respect to an initial consonant, a vowel, and a final consonant, according to an exemplary embodiment of the present invention;

FIGS. 9A through 9J illustrate a diagram for explaining a principle of generating a symbol image corresponding to an Arabic numeral in a numeral image frame in the present invention;

FIGS. 10A through 10Z illustrate a diagram showing a principle of generating a symbol image corresponding to an English capital letter in the present invention;

FIG. 11 illustrates a diagram showing an alphabet ‘E’ as an example of distinguishing a margin from a symbol image according to a thickness of a line, in the present invention;

FIG. 12 illustrates a diagram showing a symbol image representing ‘TOM’ as an example of implementing letters respectively in divided spaces different from each other, in the present invention;

FIGS. 13A through 13D illustrates a diagram for showing an example of implementing [symbol] and [symbol] in a space in the present invention;

FIG. 14 illustrates a diagram for showing an example of implementing [symbol] and [symbol] in a space, in the present invention;

FIG. 15 illustrates a diagram for showing an example of implementing ‘T’, ‘O’, and ‘M’ in a space in the present invention;

FIGS. 16A through 16C illustrates a diagram for showing an example of displaying a symbol image if ‘X’ and ‘K’ overlap with each other in the present invention;

FIGS. 17 and 18 illustrate diagrams for showing an example of an input unit that may be used, in the present invention;

FIG. 19 is a diagram illustrating an example of a dedicated keyboard via which a symbol image may be input;

FIGS. 20 and 21 illustrate diagrams for explaining a method of recognizing a photographed object as a symbol image, and inputting a symbol image based on the recognition;

FIGS. 22 and 23 illustrate diagrams for showing an example of implementing a symbol image by using a shape of a hand in the present invention;

FIG. 24 is a block diagram showing a configuration of a symbol image training apparatus in the present invention;

FIG. 25 is a flowchart of a symbol image education method according to an exemplary embodiment of the present invention;

FIGS. 26 through 30 illustrate diagrams showing an example of explaining a type of a question in the present invention; and

FIG. 31 is a flowchart showing a symbol image education method according to another embodiment of the present invention.

### BEST MODE

The description, provided hereinafter, merely illustrates principles of the present invention. Therefore, one of ordinary skill in the art may implement the principles of the present invention and invent a wide variety of devices that are included in the concept and scope of the inventive concept, though not clearly described or illustrated herein. In addition, it needs to be understood that all conditional terms and embodiments, listed herein, are intended only for the purpose of helping to understand the concept of the present invention, and are clearly not limited to the embodiment and states that are particularly enumerated herein. In addition, it may be understood that a detailed description that provides particular embodiments as well as the principles, perspectives, and embodiments of the present invention are intended to include structural and functional equivalents of the particular embodiments as well as the principles, perspectives, and embodiments of the inventive concept. Additionally, it may be understood that such equivalents include not only known equivalents but also equivalents that will be developed in the future, that is, all elements that are invented to perform the same functions regardless of structures.

Therefore, functions of various elements shown in the drawing that includes a processor or a functional block which is shown to have a concept similar to the processor may be provided by using not only dedicated hardware but also hardware with a capability to run appropriate software. If provided by the processor, the functions may be provided by a single dedicated processor, a single shared processor, or a plurality of individual processors, and some of the functions may be shared by such processors. In addition, terms such as a processor, control, or terms that have a concept similar thereto shall not be interpreted to exclusively quote hardware with a capability to run software, and shall be understood to implicitly include digital signal processor (DSP) hardware, read-only memory (ROM) for storing software, random access memory (RAM), and non-volatile memory without limitation, as well as other well-known hardware.

A purpose, advantages, and features, described above, will become apparent from the following detailed description in conjunction with the accompanying drawings. In the description of the present invention, certain detailed explanations of well-known functions or configurations are omitted when it is deemed that they may unnecessarily obscure the essence of the inventive concept.

It will be further understood that the terms “comprises,” “comprising,” “includes,” and/or “including,” when used herein, specify the presence of components, but do not preclude the presence or addition of one or more other components, unless otherwise specified.

Hereinafter, exemplary embodiments of the present invention will be described in detail with reference to the accompanying drawings.

The present invention relates to a system and method of educating a user about a symbol image by using a format such as a quiz

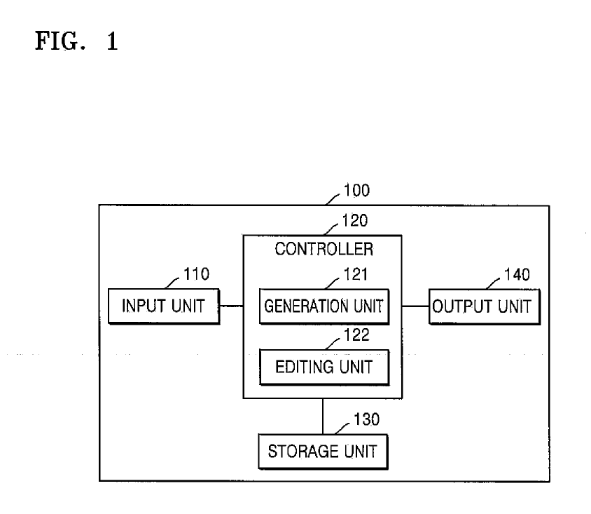

FIG. 1 is a block diagram showing a configuration of a symbol image editing apparatus 100 according to an exemplary embodiment.

In the present invention, the symbol image editing apparatus 100 receives an input of a symbol or letter from a user or an external apparatus, and outputs a symbol or a letter corresponding to the received letter or the received symbol. The symbol image editing apparatus 100 may be used as an input/output apparatus for symbol image education in the present invention.

A symbol image, used herein, is described before each element is described.

In the present invention, a symbol image refers to an image obtained by representing a letter (including a letter of various languages such as Hangul, English, a numeral, or the like) as a symbol. In detail, a symbol image is obtained by disposing at least one representation image in a space block (for example, a rectangular image frame) so as to represent a letter based on a position of the representation image and a shape of a margin.

Here, the representation image refers to an image obtained by representing a shape of a margin in a letter, as a dot, a line, etc. The representation image may be represented by various shapes such as a rectangle, a circle, or the like. A shape of a margin is determined by a space block, a location of a representation image, and a shape of the representation image.

In practicing the present invention, in a case of one or more letters (including Hangul vowels such as [symbol] , [symbol] , and [symbol] , an English lowercase letter l, and a numeral 1, and the like), a representation object may not be disposed.

In the present invention, a symbol image relates to a symbolized letter that symbolically represents a letter by defining a margin, generated according to a shape of the letter, as a space and symbolizing a shape of the margin. A letter may be represented by using a symbolized object, and designed by using various methods.

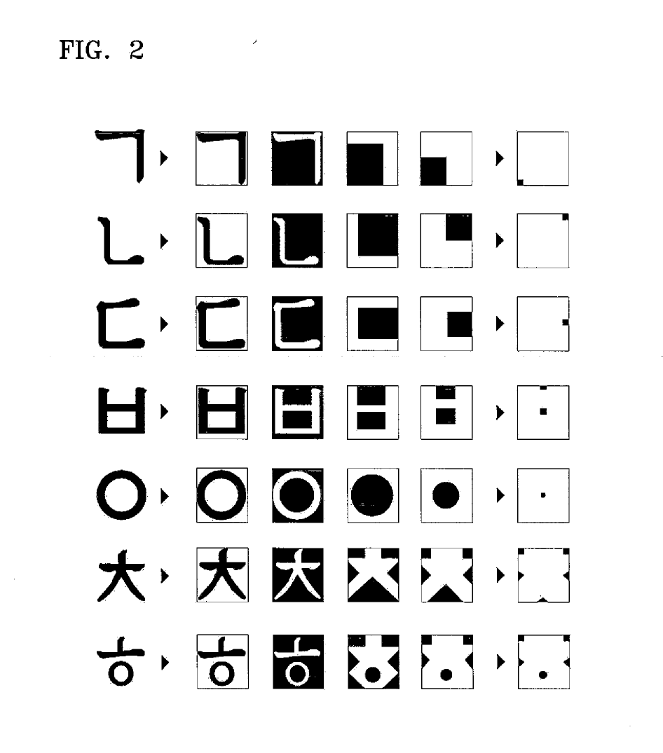

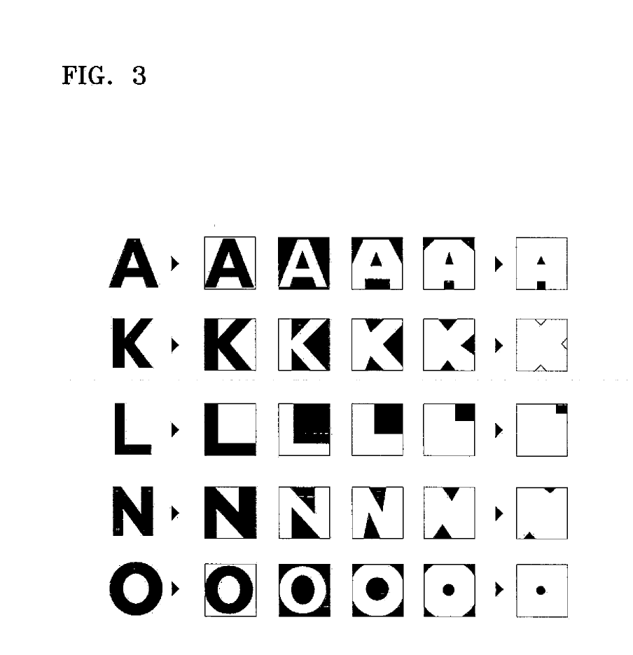

FIG. 2 illustrates a diagram showing a process of symbolizing a Hangul letter and expressing the Hangul letter as a symbol image in the present invention. FIG. 3 illustrates a diagram showing a process of representing an English alphabet as a symbol image, in the present invention.

A symbol image corresponding to a Hangul or English letter symbolically represents a letter of a language or a numeral. A symbol image is an image in which at least one representation image is disposed in a part of a space obtained by dividing (space division) a space block (for example, a rectangular image frame) for representing at least one Hangul letter (at least one syllable). The representation image is a simplified shape which is obtained by placing a letter of a language (Hangul, English, or the like) or a numeral in a frame and simplifying a shape of an empty space, as a dot, a line, a surface, or the like. The dot may be changed into various shapes such as a triangle, a rectangle, a circle, or the like.

A letter of a language or a numeral may be defined as an object having a volume and a mass, instead of a planar target used in printing. A symbol image is obtained based on letter/numeral processing technology of simply and symbolically representing a letter or a numeral in a frame by placing an object having a volume and a mass in the frame, pouring molten metal into an empty space of the frame, and processing casting obtained by pouring the molten metal. FIG. 2 shows an example of a process of processing a letter or a numeral in plan view.

In other words, a spatial concept is provided to represent a letter of a language or a numeral as a simplified space. The letter of the language or the numeral is processed to extract a symbol that may simply represent the simplified space, such as a triangle, a rectangle, a circle, or the like. Then, the symbol is disposed in a space to symbolically represent the numeral or the letter of the language.

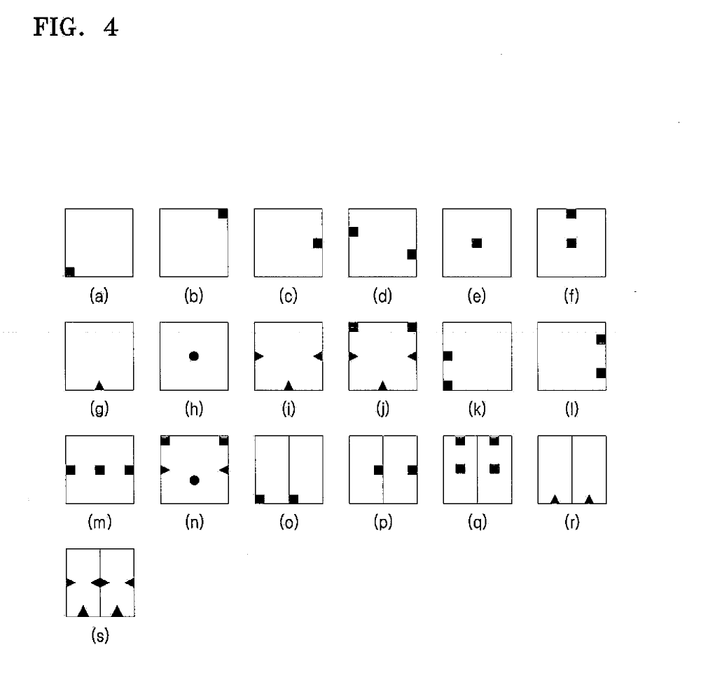

In detail, FIGS. 4A through 4S, FIGS. 5A through 5U, FIGS. 6A through 6K, FIGS. 7A through 7I, FIGS. 8A through 8F, FIGS. 9A through 9J, and FIGS. 10A through 10Z show a form of a symbol image corresponding to each letter.

In a case of Hangul, a total of 19 initial consonants of Hangul are needed to input Hangul. The initial consonants include 14 single consonants such as [symbol] , [symbol] [symbol] , and [symbol] , and double consonants such as [symbol] , [symbol] , and [symbol] .

A total number of 21 vowels of Hangul are needed to represent Hangul. The vowels include 10 single vowels such as [symbol] [symbol] , and [symbol] , and 11 double vowels such as [symbol] [symbol] [symbol] , and [symbol] .

Additionally, a total number of 27 final consonants of Hangul are needed to represent Hangul. The final consonants include 14 single consonants, 2 double consonants, and 11 consonant digraphs such as [symbol] [symbol] [symbol] , and [symbol] .

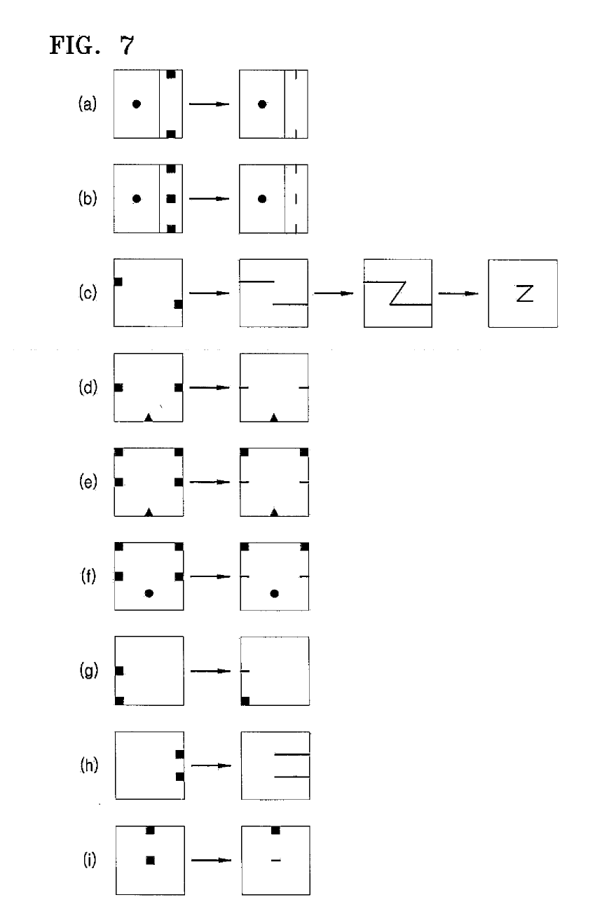

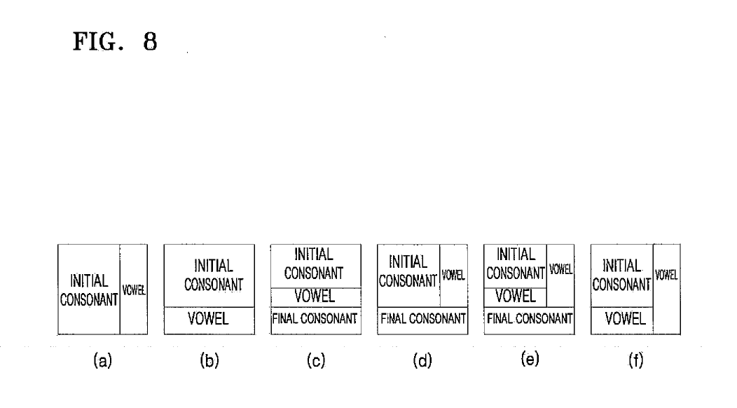

FIGS. 4A through 4S, FIGS. 5A through 5U, and FIGS. 6A through 6K illustrate diagrams showing examples of generating a symbol image corresponding to Hangul, according to an exemplary embodiment of the present invention. FIGS. 7A through 7I illustrate diagrams showing an example of representing a symbol image of an initial consonant, a vowel, and a final consonant by using a dot, a line, and a surface together. FIGS. 8A through 8F illustrate diagrams showing an example of an initial consonant, a vowel, and a final consonant in a divided space. Here, a divided space refers to an area obtained by dividing a space block, for example, so as to distinguishing an initial consonant, a vowel, and a final consonant of Hangul from each other.

A principle of generating a symbol image corresponding to an initial consonant of Hangul is described with reference to FIGS. 4A through 4S. In detail, FIG. 4A shows a rectangular representation image generated in a left lower part of a space which is a position of a margin in [symbol] . FIG. 4B shows a rectangular representation image that has a shape of a margin in [symbol] and is generated in a right upper part of a space which is a position of the margin in [symbol] . FIG. 4C shows a rectangular representation image that has a shape of a margin in [symbol] and is generated in a right center part of a space which is a position of the margin in [symbol] .

Additionally, FIG. 4D shows rectangular representation images that have a shape of a margin in [symbol] and are generated in a position of the margin in [symbol] . FIG. 4E shows a rectangular representation image that has a shape of a margin in [symbol] and is generated at a center of the space which is a position of the margin in [symbol] in a space. FIG. 4F shows rectangular representation images that have a shape of a margin in [symbol] and are respectively generated at a center and in an upper center part of a space which are locations of the margin in [symbol] . FIG. 4G shows a triangular representation image that has a shape of a margin in [symbol] and is generated in a lower center part of a space which is a position of the margin in [symbol] in the space. Additionally, FIG. 4H shows a circular representation image that has a shape of a margin in [symbol] and is generated at a center of a space which is a position of the margin in [symbol] in the space.

As a reference, in the present invention, only when a shape of a margin in each image of a Hangul letter is rectangular, triangular, or circular, a symbol image of the Hangul letter is generated in a location of a space corresponding to a position of a margin of the Hangul letter by using a representation image having a shape identical to a shape of the margin. However, a representation image having a shape different from a shape of a margin may be inserted into a position of the margin in each image of a Hangul letter.

This is because a position of a margin in an image of a Hangul letter is the most important characteristics in determining unique characteristics of the Hangul letter. For example, although a triangular representation image is used to represent [symbol] in FIG. 4G, even when a rectangular or circular representation image is used, a symbol image having the rectangular or circular representation image may be distinguished from a symbol image of another letter. Accordingly, a representation image, which is different from a representation image used in FIG. 4G, may be used.

According to a rule described above, other symbol images are analyzed as shown in FIGS. 4I through 4S. FIG. 4I shows a symbol image corresponding to [symbol] . FIG. 4J shows a symbol image corresponding to [symbol] . FIG. 4K shows a symbol image corresponding to [symbol] . FIG. 4L shows a symbol image corresponding to [symbol] . FIG. 4M shows a symbol image corresponding to [symbol] . FIG. 4N shows a symbol image corresponding to [symbol] . FIG. 4O shows a symbol image corresponding to [symbol] . FIG. 4P shows a symbol image corresponding to [symbol] . FIG. 4Q shows a symbol image corresponding to [symbol] . FIG. 4R shows a symbol image corresponding to [symbol] . FIG. 4S shows a symbol image corresponding to [symbol] .

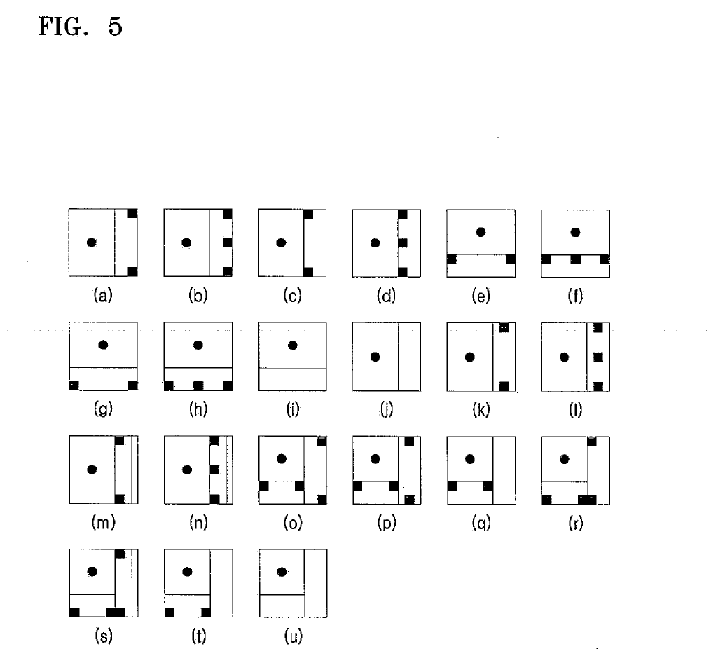

FIGS. 5A through 5U illustrate diagrams for explaining a principle of generating a symbol image corresponding to a letter in which an initial consonant and a vowel of a Hangul letter are combined with each other. FIGS. 5A through 5U show a vowel combined with a consonant [symbol] instead of showing a vowel alone, so as to easily recognize the vowel. As shown in FIGS. 5A through 5U, when a symbol image corresponding to a letter in which an initial consonant and a vowel are combined with each other is generated, the rectangular image frame shown in FIGS. 4A through 4S is divided into an initial consonant area and a vowel area as shown in FIGS. 8A and 8B (which is referred to as ‘space division), and then, representation image respectively corresponding to an initial consonant and a vowel are generated respectively in an image frame for the initial consonant and an image frame for the vowel.

A principle of generating a representation image corresponding to an initial consonant in the image frame for the initial consonant is identical to the principle described with reference to FIGS. 4A through 4S. In the present invention, a representation image corresponding to a vowel in an image frame for a vowel is generated by generating a rectangular representation image, having a same shape as that of a margin in the vowel, in a location corresponding to a position of the margin in the vowel in the image frame for the vowel.

According to a rule described above, letters represented by each of the symbol images are analyzed as shown in FIGS. 5A through 5U. FIG. 5A shows a symbol image corresponding to [symbol] . FIG. 5B shows a symbol image corresponding to [symbol] . FIG. 5C shows a symbol image corresponding to [symbol] . FIG. 5D shows a symbol image corresponding to [symbol] FIG. 5E shows a symbol image corresponding to [symbol] . FIG. 5F shows a symbol image corresponding to [symbol] . FIG. 5G shows a symbol image corresponding to [symbol] . FIG. 5H shows a symbol image corresponding to [symbol] . FIG. 5I shows a symbol image corresponding to [symbol] . FIG. 5J shows a symbol image corresponding to [symbol] . FIG. 5K shows a symbol image corresponding to [symbol] . FIG. 5L shows a symbol image corresponding to [symbol] .

In a case of a single vowel [symbol] and a double vowel [symbol] , as shown in FIGS. 5M and 5N, an image frame for a vowel is divided vertically into two areas, and thus, [symbol] may be represented as [symbol] in each of the two areas, and [symbol] may be represented as [symbol] so as to distinguish [symbol] and [symbol] respectively from [symbol] and [symbol] . As such, FIG. 5M shows a symbol image corresponding to [symbol] . FIG. 5L shows a symbol image corresponding to [symbol] .

In a case of a double vowel from among vowels, an image frame for a vowel may be divided into an upper part, a lower part and a right end part of the image frame, and then, a representation image of each vowel included in the double vowel may be individually generated. Thus, FIG. 5O shows a symbol image corresponding to [symbol] . FIG. 5P shows a symbol image corresponding to [symbol] . FIG. 5Q shows a symbol image corresponding to [symbol] . FIG. 5R shows a symbol image corresponding to [symbol] . FIG. 5S shows a symbol image corresponding to [symbol] . FIG. 5T shows a symbol image corresponding to [symbol] . FIG. 5U shows a symbol image corresponding to [symbol] .

When a symbol image corresponding to a letter in which an initial consonant, a vowel, and a final consonant are combined with each other, the rectangular image frame shown in FIGS. 4A through 4S is divided into an initial consonant area, a vowel area, and a final consonant area as shown in FIGS. 8C through 8F (which is referred to as ‘space division), and then, representation images respectively corresponding to the initial consonant, the vowel, and the final consonant are generated respectively in an image frame for the initial consonant, an image frame for the vowel, and an image frame for the final consonant.

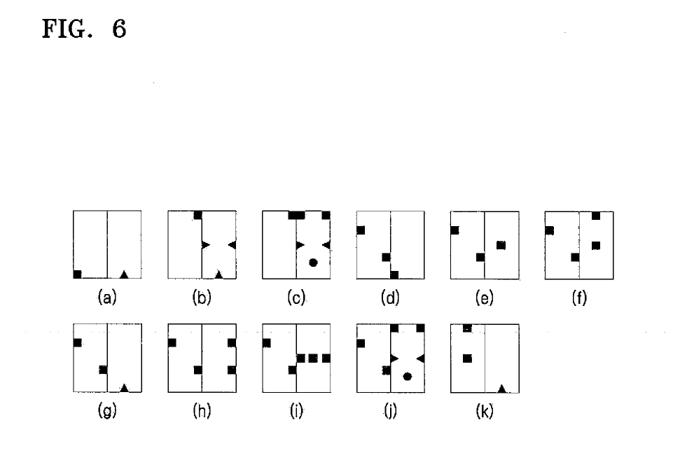

FIGS. 6A through 6K illustrate diagrams showing a principle of generating a symbol image corresponding to a final consonant of a Hangul letter in an image frame for a final consonant. Since both the 14 single consonants including [symbol] [symbol] , [symbol] , and [symbol] and the 2 double consonants including [symbol] and [symbol] , described with reference to FIGS. 4A through 4S, may be used as a final consonant of Hangul, a description thereof is not provided here again. Accordingly, a principle of generating a symbol image corresponding to 11 consonant digraphs such as [symbol] , [symbol] , and [symbol] which are used only as a final consonant of Hangul is described with reference to FIGS. 6A through 6K.

In a case of a consonant digraph that is not used as an initial consonant but as a final consonant from among double consonants of Hangul, like other double consonants of Hangul, an image frame for a final consonant is divided into two areas, and then, a representation image corresponding to each consonant of the consonant digraph is respectively generated in the two areas of the image frame for the final consonant.

Accordingly, FIG. 6A shows a symbol image corresponding to [symbol] , and FIG. 6B shows a symbol image corresponding to [symbol] . FIG. 6C shows a symbol image corresponding to [symbol] . FIG. 6D shows a symbol image corresponding to [symbol] . FIG. 6E shows a symbol image corresponding to [symbol] . FIG. 6F shows a symbol image corresponding to [symbol] . FIG. 6G shows a symbol image corresponding to [symbol] . FIG. 6H shows a symbol image corresponding to [symbol] . FIG. 6I shows a symbol image corresponding to [symbol] . FIG. 6J shows a symbol image corresponding to [symbol] . FIG. 6K shows a symbol image corresponding to [symbol] .

As such, a symbol image may be generated according to the principles described with reference to FIGS. 4A through 4S, 5A through 5U, and 6A through 6K. Alternately, a symbol image may be generated according to a shape obtained by transforming a representation image as described with reference to FIGS. 7A through 7I.

In detail, as shown in FIGS. 7A and 7B, short vertical lines may be generated to replace rectangular representation images that have a shape representing a vowel. As shown in FIG. 7C, long horizontal lines may be generated to replace rectangular representation images at left and right sides of the image frame, having shapes representing [symbol] from among consonants. Additionally, rectangular representation images may be represented in a form of ‘Z’ by connecting long horizontal lines to each other by using a diagonal line. Alternately, the rectangular representation images may be represented in a form of ‘z’ whose size is reduced from ‘Z’. Additionally, as shown in FIGS. 7D through 7F, short horizontal lines may be generated to respectively replace rectangular representation images in a middle of right and left ends, from among representation images used to represent [symbol] , and [symbol] . Additionally, as shown in FIG. 7G, a short horizontal line may be generated to replace only a rectangular representation image in a middle of a left end, from among shapes representing [symbol] .

Alternately, as shown in FIG. 7H, long horizontal lines may be generated to replace rectangular representation images at a right end of the image frame having a shape representing [symbol] . Alternately, as shown in FIG. 7I, a short line may be generated to replace only a rectangular representation image at a center of an image frame, from among shapes representing [symbol] .

10 digits in total may be needed to represent Arabic numerals in a numeral input mode. In other words, Arabic numerals consist of 10 digits such as ‘0’, ‘1’, ‘2’, ‘3’, ‘4’, ‘5’, ‘6’, ‘7’, ‘8’, and ‘9’.

Symbol images of Arabic numerals may be represented by disposing a representation object in a part of a space block (for example, a rectangular image frame). However, since numerals are not divided into an initial consonant, a vowel, and a final consonant, the space block may not be divided (space division). A representation object refers to an object obtained by putting an Arabic numeral into a frame, and simplifying a shape of the Arabic numeral, determined from an empty space in the frame, as a dot, a line, a surface, or the like. The dot may be changed into various shapes such as a triangle, a rectangle, a circle, or the like.

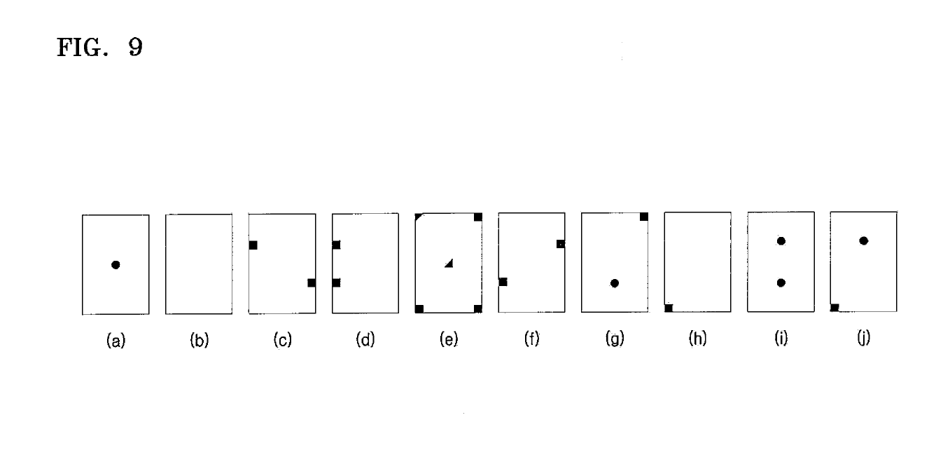

FIGS. 9A through 9J illustrate diagrams for explaining a principle of generating a symbol image corresponding to an Arabic numeral in a numeral image frame. FIG. 9A shows a symbol image corresponding to a numeral ‘0’. FIG. 9B shows a symbol image corresponding to a numeral ‘1’. FIG. 9C shows a symbol image corresponding to a numeral ‘2’. FIG. 9D shows a symbol image corresponding to a numeral ‘3’. FIG. 9E shows a symbol image corresponding to a numeral ‘4’. FIG. 9F shows a symbol image corresponding to a numeral ‘5’. FIG. 9G shows a symbol image corresponding to a numeral ‘6’. FIG. 9H shows a symbol image corresponding to a numeral ‘7’. FIG. 9I shows a symbol image corresponding to a numeral ‘8’. FIG. 9J shows a symbol image corresponding to a numeral ‘9’.

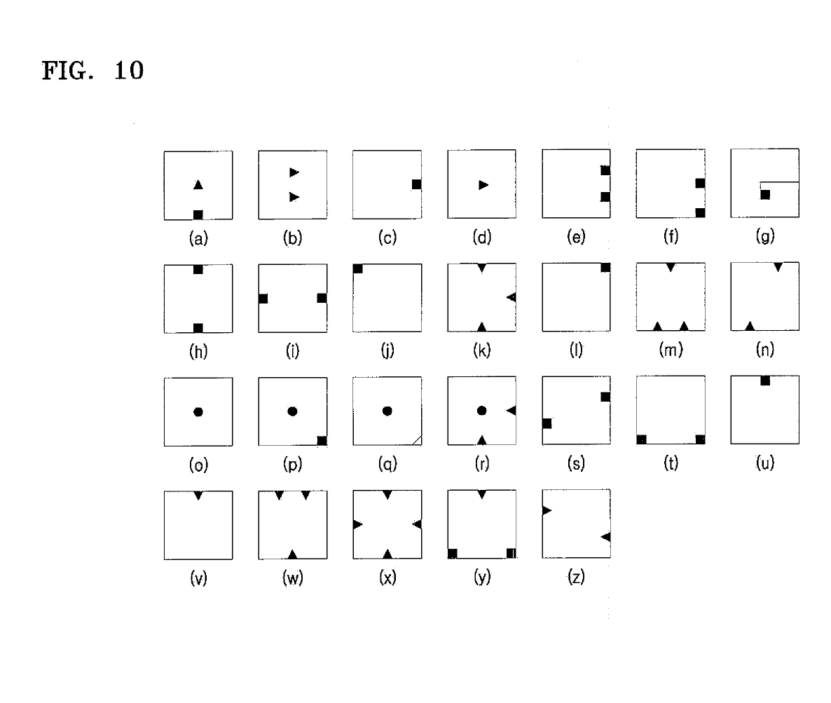

FIGS. 10A through 10Z illustrate diagrams showing a principle of generating a symbol image corresponding to an English uppercase letter.

A total of 52 English alphabets, which include 26 uppercase letters and 26 lowercase letters, may be used to represent English words in an English word input mode. 21 alphabets from among 26 uppercase (or lowercase) alphabets, other than 5 vowel alphabets such as “A(/a)”, “E(/e)”, “I(/i)”, “O(/o)”, and “U(/u)”, are referred to as ‘consonant alphabets’. In other words, English uppercase and lowercase alphabets consist of 21 consonant alphabets (that is, ‘B(/b)’, ‘C(/c)’, ‘D(/d)’, ‘G(/g)’, ‘H(/h)’, ‘J(/j)’, ‘K(/k)’, ‘L(/l)’, ‘M(/m)’, ‘N(/n)’, ‘P(/p)’, ‘Q(/q)’, ‘R(/r)’, ‘S(/s)’, ‘T(/t)’, ‘V(/v)’, ‘W(/w)’, ‘X(/x)’, ‘Y(/y)’, and ‘Z(/z)’), and 5 vowel alphabets (that is, ‘A(/a)’, ‘E(/e)’, ‘I(/i)’, ‘O(/o)’, and ‘U(/u)’). The English uppercase/lowercase alphabets are represented as shown in FIGS. 10A through 10Z.

A representative example of generating a symbol image according to the same rule is described above. However, exemplary embodiments are not limited thereto, and a symbol image may be generated by using various methods.

For example, a margin may have a pattern or a color, if the margin is distinguished from a representation image.

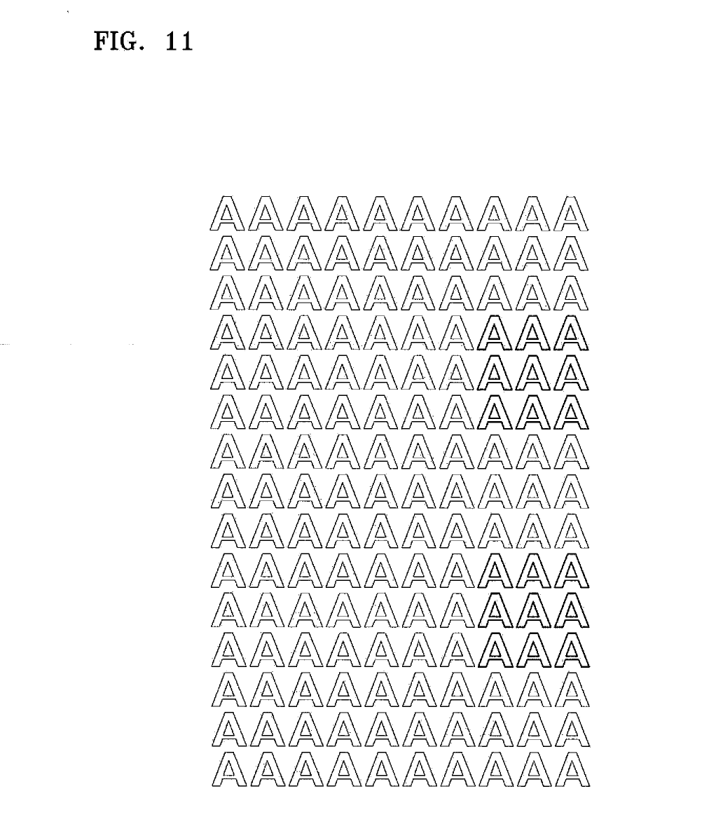

FIG. 11 illustrates a diagram showing an alphabet ‘E’ as an example of distinguishing a margin from a representation image according to a thickness of a line, in the present invention.

A space block may not need to be a rectangle, and may not need to have a fixed size.

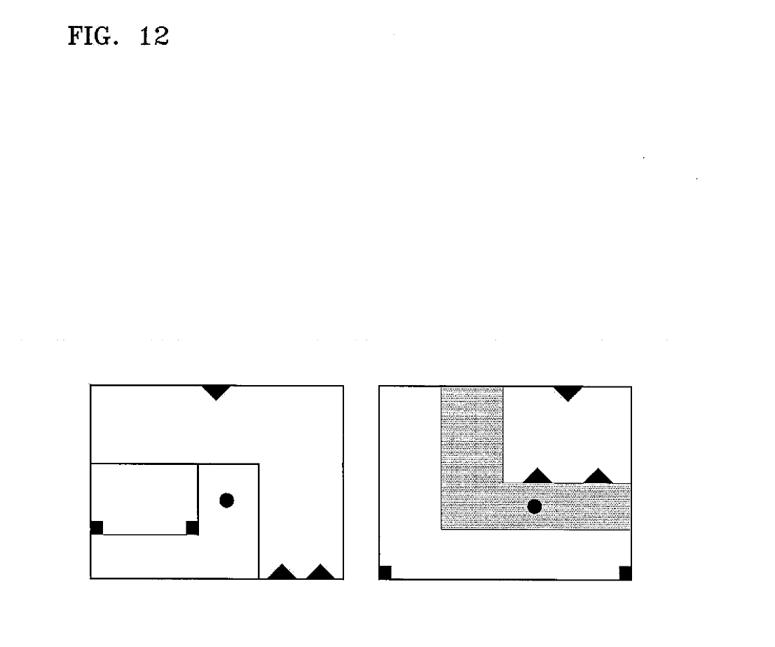

FIG. 12 illustrates a diagram showing a symbol image representing ‘TOM’ as an example of implementing letters respectively in divided spaces.

Additionally, a space block may not include just one letter, and a plurality of letters may overlap with each other.

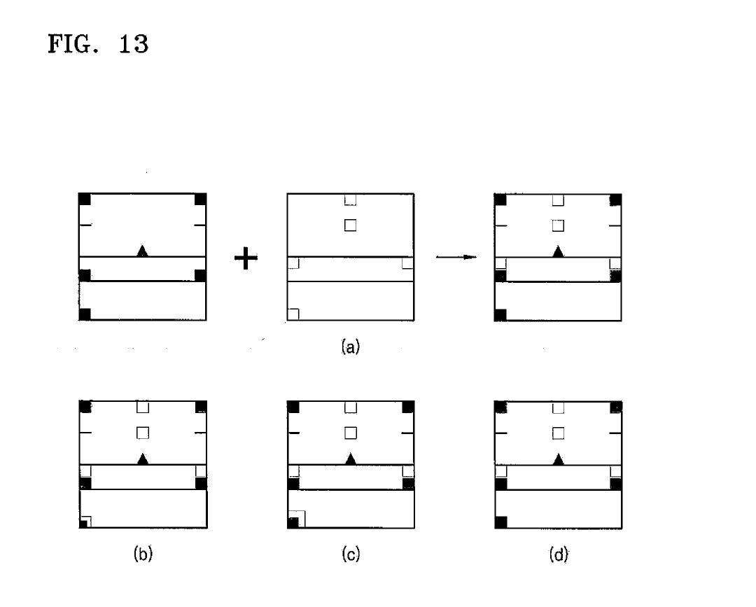

According to a principle of generating a plurality of symbol images overlapping with each other, two symbol images (layers 1 and 2) are overlapping with each other to achieve disposition and space dividing of complicated representation objects as shown in FIGS. 13A through 13D.

FIGS. 13A through 13D illustrates a diagram for showing an example of implementing [symbol] and [symbol] in a space. FIG. 13A shows a process of implementing [symbol] and [symbol] in a space, and FIGS. 13B through 13D show various examples of overlapping symbol images with each other.

Before letters are overlapped with each other, representation objects of letters need to be marked differently from each other so that the letters are easily identified after the letters overlap with each other. Shapes, locations, sizes, and degrees of transparency of the representation objects may be marked as being different from each other, or the representation objects may be distinguished from each other by using a letter, a sign, or the like. The symbols may be most easily distinguished from each other by using colors.

A letter [symbol] is colored black as shown in a first image in FIG. 13A, and a letter [symbol] is colored gray as shown in a second image in FIG. 13A. Then, two symbol images are overlapped with each other, and thus, represented as shown in a third image in FIG. 13A. Since a final consonant of [symbol] and [symbol] is [symbol] , if shapes and sizes corresponding to [symbol] are identical to each other, a shape in a first symbol image (layer 1) covers a shape (an image of a final consonant) in a second signal image (layer 2). In this case, a size of the shape (the image of the final consonant) in the first symbol image (layer 1) may be reduced as shown in FIG. 13B, or a size of the shape of second symbol image (layer 2) is increased as shown in FIG. 13B. Thus, an overlapping state of two symbol images are clearly shown by differentiating sizes of the figures in the two symbol images from each other.

Additionally, if the shape in the second symbol image is covered by the shape in the first symbol image and this covering is easily recognized, the shape in the second symbol image may not be marked as shown in FIG. 13D.

The overlapped two symbol images (layers 1 and 2) are provided with unique characteristics so that the two symbol images are distinguished from each other. According to the unique characteristics, layers may be separated from each other so that letters in the layers may be distinguished from each other. According to an exemplary embodiment, the unique characteristics provided to a layer may be a color, texture (strictly speaking, visual characteristics), brightness, chroma, a shape, light and shade, a pattern, a size, a location, or a degree of transparency. Additionally, the unique characteristics may be determined by using various methods such as two-dimensional (2D) or three-dimensional (3D) space separation, or the like.

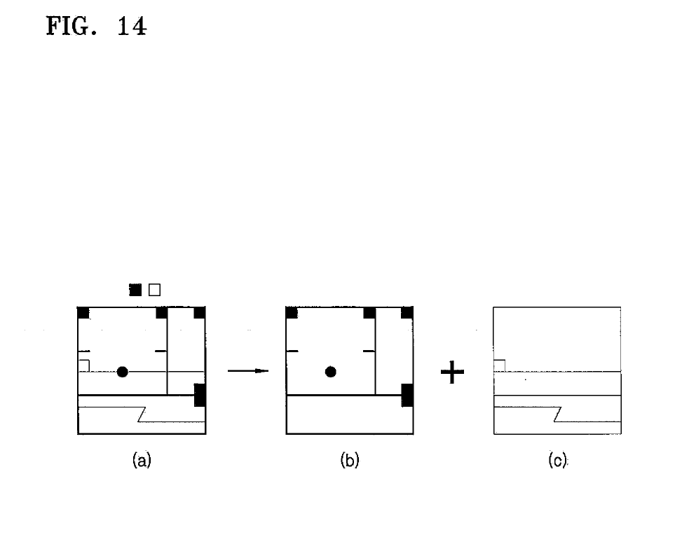

For example, as shown in FIG. 14, an order of overlapped layers is shown by marking a distinguisher, having same characteristics as those of each layer, on overlapping layers. Since a distinguisher is used to show an order of the layers and decorate the layers, the distinguisher may be marked in correspondence with an amount of the layers, or may be marked regardless of an amount of the layers. An order of the layers may be determined by using the distinguisher, and a number of the layers may be determined by a number of types of representation shapes in overlapped symbol letters. If letters are shown in a vertical direction, an order of distinguishers is determined as being from an ‘upward’ to ‘downward’ direction. If letters are shown in a horizontal direction, an order of distinguishers is determined as being from a ‘left to ‘right direction. Accordingly, a distinguisher located at an uppermost position at a left side indicates a first layer.

As an example, a distinguisher (a black distinguisher) that is identical to one from among a color, a location, a size, a degree of transparency, brightness, light and shade, a pattern, and texture of a first symbol image (layer 1), which is generated first, is marked on a first position as shown in FIG. 14A, and a distinguisher (a gray distinguisher) that is identical to one of a color, a location, a size, a degree of transparency, brightness, light and shade, a pattern, and texture of the second symbol image (layer 2), which is generated late, is marked on the second on a second position as shown in FIG. 14A. From among the two overlapping symbol images (layers 1 and 2) shown in FIG. 14A, [symbol] is read from an image shown in FIG. 14B, and then, [symbol] is read from an image shown in FIG. 14C according to an order of distinguishers. Thus, the two overlapping image shown in FIG. 14A may be read as [symbol] .

A computer apparatus may distinguish overlapping symbol images, implemented in a design object, from each other by using distinguishers. In detail, from among the two overlapping symbol images (layers 1 and 2) as shown in FIG. 14A, an operation unit 470 may read [symbol] as shown in FIG. 14B, and then, [symbol] as shown in FIG. 14C according to an order of distinguishers, and thus, read and analyze the overlapping symbol images as [symbol] , as shown in FIG. 14A.

In the present invention, a symbol image may be variously applied to letters such as not only Hangul letters (including a consonant, a vowel, a syllable, a word, or the like), English letters (including an uppercase letter, a lowercase letter, or the like), or letters of other foreign languages, but also double letters thereof.

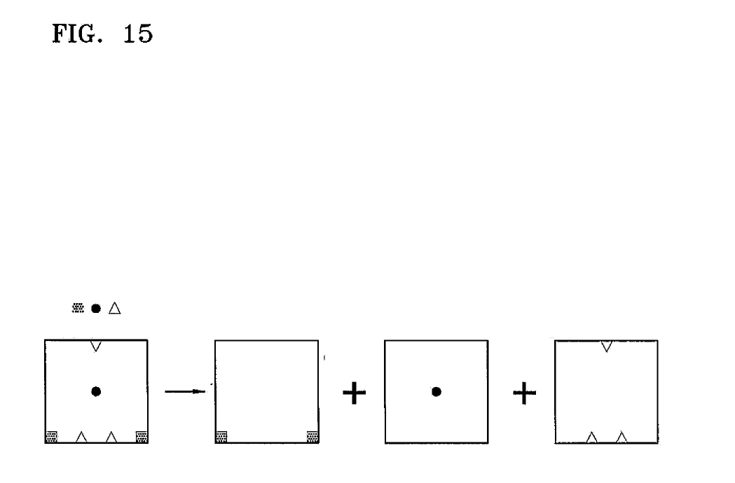

FIG. 15 illustrates a diagram for showing an example of applying overlapping images to English letters. FIG. 15 shows an example of overlapping ‘T’, ‘O’, and ‘M’ with each other in a space.

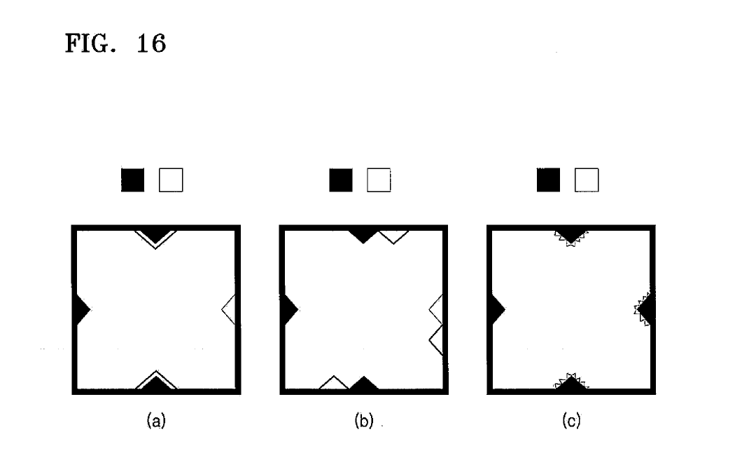

There may be a case when, since locations of representation images of respective overlapping symbol images are identical to each other, it may not be easy to accurately read each letter. In this case, overlapping of a plurality of symbol images with each other in a same location may be indicated by setting sizes of the representation images of the symbol images to be different from each other as shown in FIG. 16A, setting locations of the symbol images to be slightly different from each other as shown in FIG. 16B, or setting shapes of the symbol images to be different from each other as shown in FIG. 16C.

FIGS. 16A through 16C illustrate a diagram for showing an example of showing a representation image if ‘X’ and ‘K’ overlap with each other in the present invention.

Even when a representation image of a symbol image is covered by a representation images of another symbol image, if each of the symbol images may be recognized, the method described above may not be applied.

Referring back to FIG. 1, in the present invention, the symbol image editing apparatus 100 includes an input unit 110, a controller 120, a storage unit 130, and an output unit 140.

According to an exemplary embodiment of the present invention which is to be described later, the symbol image editing apparatus 100 may independently operate. Alternately, according to another exemplary embodiment which is to be described later, the symbol image editing apparatus 100 may communicate with an external apparatus (which is an apparatus identical to the symbol image editing apparatus 100, and is included in or works with another communication terminal) via a data communication network.

The data communications network may be a wired or wireless telephone network, the Internet, Bluetooth, or the like. The communication terminal may be a communication device that may perform wired/wireless data communication, such as a wired/wireless phone, a session initiation protocol (SIP) terminal, a cellular phone, a personal digital assistant (PDA), a general personal computer (PC), a handheld PC, a laptop computer equipped with a wired/wireless modem, smart glasses, a smart camera, a smart watch, a black box, a navigation system, a video recording apparatus, or the like.

In the present invention, the symbol image editing apparatus 100 may be used as a part of an education apparatus in the present invention, or may be independently used to input/output a symbol or a letter. The symbol image editing apparatus 100 is basically used to input/output a symbol or a letter, and a program for generating a quiz or exchange a quiz with other people may be further provided to the symbol image editing apparatus 100 for the purpose of education. Here, a case when the symbol image editing apparatus 100 is basically used to input/output a symbol or a letter is described.

According to an exemplary embodiment, the symbol image editing apparatus 100 converts a letter (including a numeral) of a language (Hangul, English, or the like), input via the input unit 110, into a symbol image and outputs the symbol image to the output unit 140 in real time. Additionally, the symbol image editing apparatus 100 interprets a symbol image, input via the input unit 110, and outputs a letter of a language (including a numeral) corresponding to the symbol image via the output unit 140 in real time. In other words, according to an exemplary embodiment, the symbol image editing apparatus performs both of the input and output processes.

According to another exemplary embodiment, the symbol image editing apparatus 100 transmits letter information (including numeral information) about a language, input via the input unit 110, to an external apparatus. Additionally, the symbol image editing apparatus 100 interprets a symbol image, input via the input unit 110, and transmits letter information about a language (including numeral information) corresponding to the symbol image to the external apparatus. In other words, according to another exemplary embodiment, the symbol image editing apparatus 100 performs an input process, and performs an output process via an external apparatus.

According to another exemplary embodiment, the symbol image editing apparatus 100 converts a letter (including a numeral) of a language (Hangul, English, or the like), transmitted from an external apparatus, into a symbol image, and outputs the symbol image via the output unit 140 in real time. The external apparatus may transmit letter information (including numeral information) of a language (Hangul, English, or the like), input via the input unit 110, to the symbol image editing apparatus 100, or interprets a symbol image, input via the input unit 110, and transmits letter information (including numeral information) of a language corresponding to the symbol image via the output unit 140 in real time. In other words, according to another exemplary embodiment, the symbol image editing apparatus 100 performs an input process via an external apparatus, and independently performs an output process.

In practicing the present invention, according to another exemplary embodiment, an input process is performed via an external apparatus, and an output process may also be performed via another external apparatus instead of the symbol image editing apparatus 100.

In the second and third exemplary embodiment disclosed in the above, the external apparatus is an apparatus that is identical to the symbol image editing apparatus 100, and is included in another communication terminal or driven to work with another communication terminal and communicates with the symbol image editing apparatus 100 via a data communication network in the present invention.

Each element is described in detail.

The input unit 110 is used to receive an input of a letter or a symbol from a user, receive a letter, a symbol, or information corresponding to the letter or the symbol from another equipment, or receive an input of an edit command with respect to a generated symbol image from a user.

In other words, the input unit 110 is used for a user to input letter or numeral information of a language that the user wants to output (such as displaying, transmitting, printing, or the like) as a symbol image, for a user to input a symbol image that the user wants to output (such as displaying, transmitting, printing, or the like) as a letter or a number of a language, for a user to input an edit command with respect to a space block (for example, a rectangular image frame) in which a symbol image that the user wants may be represented or a divided space that is obtained by dividing the space block (for example, space division for distinguishing an initial consonant, a vowel, and a final consonant of Hangul from each other), or for a user to input an edit command with respect to a generated symbol image.

The input unit 110 may consist of a keypad, a touch screen unit, a mouse pad, a mouse, an optical pen, or the like. A letter/numeral may be input both via a touchscreen and a keypad.

The present invention may be applied to an apparatus that includes only a keypad, an apparatus that includes only a touchscreen, or an apparatus that includes both a keypad and a touchscreen.

The keypad consists of a plurality of key buttons for inputting numerals, special characters, or letters. The keypad further includes function buttons or general buttons for storing, modifying, or loading letters/numerals, and functions as a medium for transmitting an instruction by a user to the controller 120. If a user applies certain pressure to letter (consonants and vowels)/numeral keys by using a hand (or applies micro-current or uses a sensor to recognize an operation by a user), the keypad generates data needed to recognize a letter/numeral corresponding to the letter/numeral key, that is, key data, and then, transmits the key data to the controller 120. Then, the controller 120 checks letter/numeral code data corresponding to the key data in the storage unit 130, extracts a symbol image mapped with letter/numeral code data, and then, display the symbol image on the output unit 140, transmit the symbol image to the output unit 140, or print the symbol image. A method of configuring hard keys in the keypad for inputting letters or numerals, and a method of recognizing and combining letters/numerals with each other via the keypad may employ well-known technology. Thus, a description thereof is not provided here.

Additionally, the touchscreen is an element for inputting object-oriented letter/numeral information. If a user applies certain pressure to a letter (consonant or vowel)/numeral on a panel of the touchscreen by using a hand or a writing tool such as a stylus pen, the touchscreen generates data needed to recognize the letter/numeral, that is, touchscreen data, and transmits the touchscreen data to the controller 120. Then, the controller 120 checks letter/numeral code data corresponding to the touchscreen data in the storage unit 130, extracts a symbol image mapped with the letter/numeral code data, and then, display the symbol image on the output unit 140, transmit the symbol image to the output unit 140, or print the symbol image. A method of configuring soft keys in the keypad for inputting letters or numerals, and a method of recognizing and combining letters/numerals with each other via the touchscreen may employ well-known technology. Thus, a description thereof is not provided here.

A method of inputting a letter or the like via the input unit 110 is identical to an input method performed by using a keyboard, a keypad, or the like in a general computer, a smartphone, or the like. Thus, a description thereof is not provided here, and a method of inputting a symbol is described in detail.

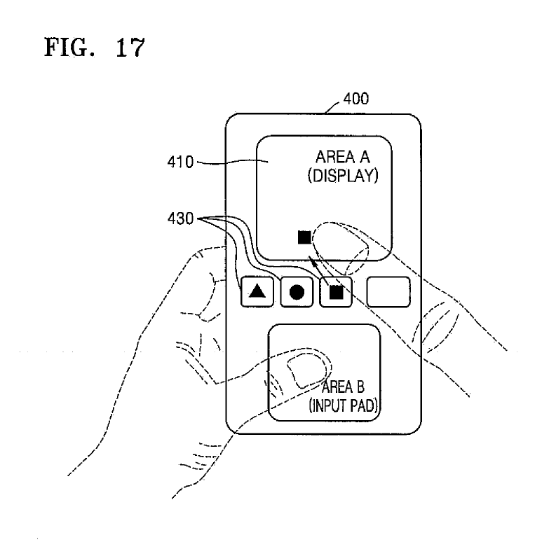

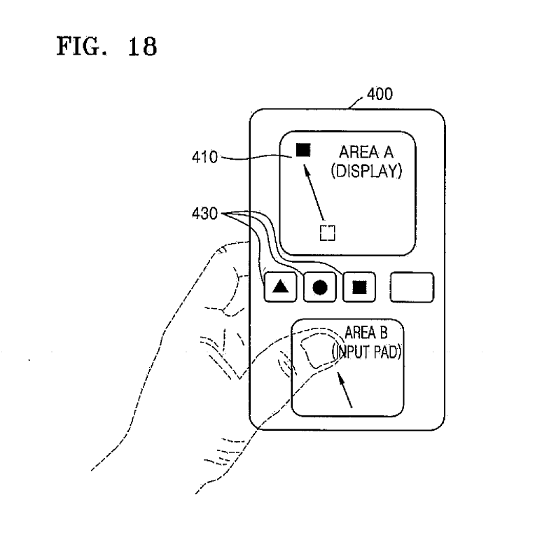

FIGS. 17 and 18 illustrate diagrams for showing an example of an input unit 430 that may be used, in the present invention.

A user may press one of a triangular button, a circular button, and a rectangular button included in the input unit 430 in a symbol image education apparatus 400 or the symbol image editing apparatus 100 so as to display a representation image (a triangle, a circle, or a rectangle) corresponding to the pressed button on a display unit 410. Then, as shown in FIG. 17, while a finger of the user contacts an input pad included in the input unit 430, the user may perform a drag operation, and thus, move a representation image, displayed on the display unit 410, to a location in the display unit 410 which the user wants.

As such, a user may freely input a symbol image, which the user wants, as a symbol image corresponding to letter information provided as a question, by using the input unit 430 shown in FIGS. 17 and 18.

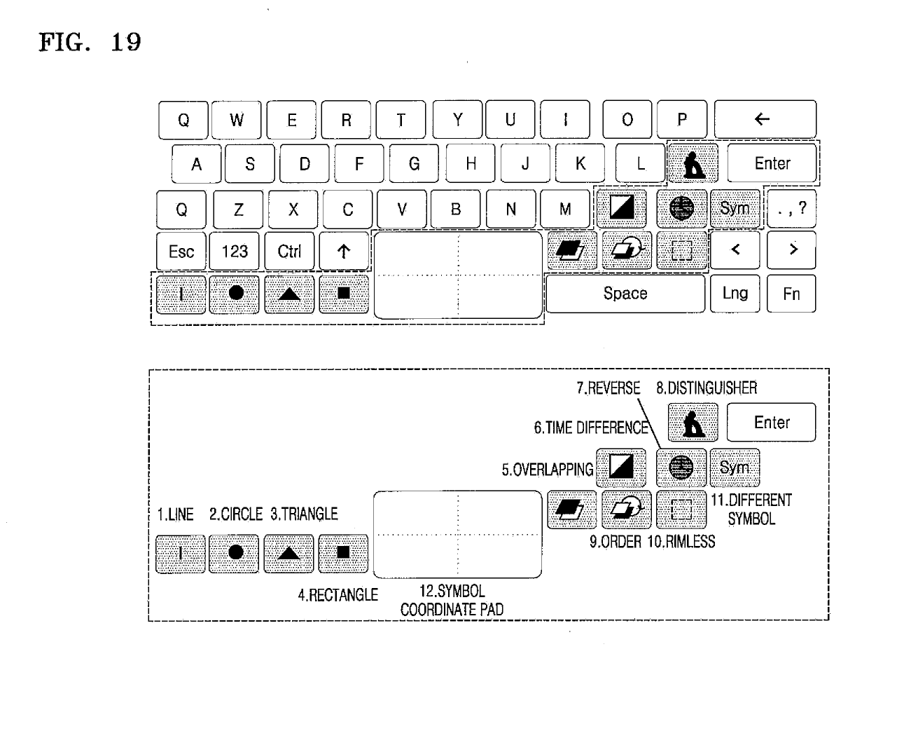

FIG. 19 is a diagram illustrating an example of a dedicated keyboard via which a symbol image may be input.

As shown in FIG. 19, keys, via which a symbol image may be input, are disposed in a part of the dedicated keyboard.

A symbol coordinate pad 12 at a lower center of the keyboard is used to designate a location of a representation image as shown in FIGS. 17 and 18. A line button 1, a circle button 2, a triangle button 3, and a square button 4 are keys used to select a corresponding representation image.

An overlapping key 5 is a key for overlapping two or more letters with each other (which is to be described later), and a toggle key 6 is a key for reversing a color of a symbol image with a color of a margin. A time button 7 is a key used to sequentially output symbol images consisting of a letter, instead of outputting the symbol images at a same time. A distinguisher button 8 is a key for inputting a distinguisher for representing an order in which a plurality of letters are read, if the plurality of letters overlap with each other. An order key 9 is a key for changing an order in which letters overlap with each other. A rimless button 10 is a key for making a space-dividing line rimless, and an another symbol key 11 is a key used to change a representation image to another representation image.

A symbol image may be input by using various methods, other than the method described above.

As an example, a user may draw a representation image and designate a location, which the user wants, on a touchscreen.

As another example, a particular object may be located in a space, the particular object may be photographed, and then, a representation image may be input according to a location of the particular object in the space. In other words, a representation image may be input by using a photographing apparatus such as a camera.

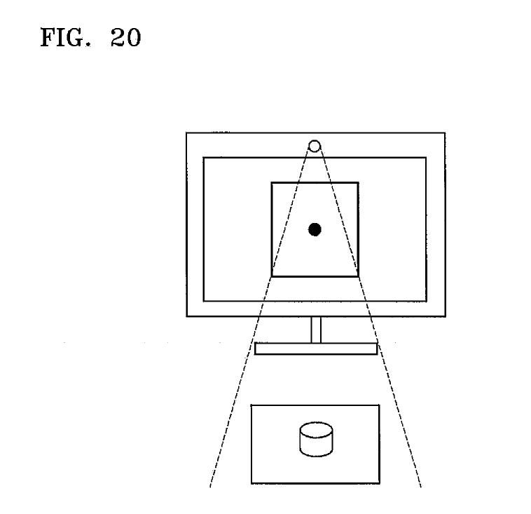

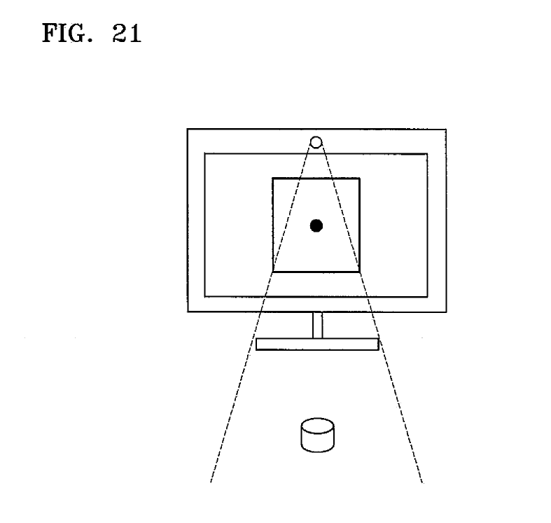

FIGS. 20 and 21 illustrate diagrams for explaining a method of recognizing a photographed object as a representation image, and inputting a representation image based on the recognition.

As shown in FIG. 20, the method of inputting a representation image by using photographing may include putting an object (circular cylinder) on a rectangular pad, recognizing, by the input unit 110, the rectangular pad as a space block, and recognizing a relative location of the object (circular cylinder) in the space block as a location of a representation image of a symbol image. Alternately, as shown in FIG. 21, the method of inputting a representation image by using photographing may include recognizing a relative location of an object (circular cylinder) as a location of a circular cylinder in a whole screen in which the object is photographed as shown in FIG. 21, instead of using a rectangular pad.

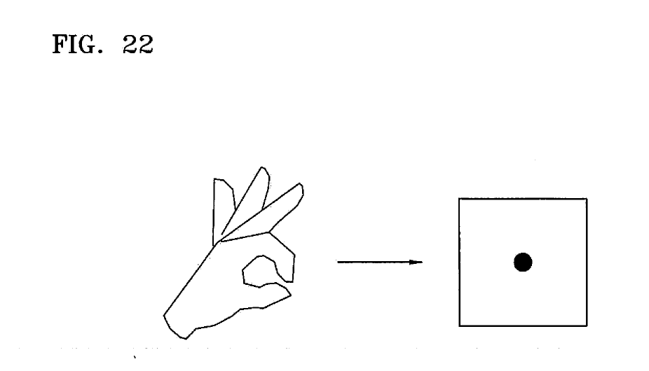

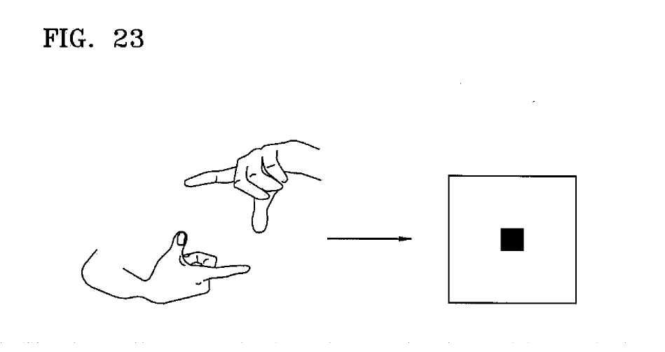

Additionally, a method of making a shape of a hand as shown in FIGS. 22 and 23, and thus, recognizing the shape of the hand so as to determine a shape of a representation image may be employed.

If a representation image is input, and then, a location of the representation image is additionally input, the location of the representation image may be designated by using various methods.

As described above, various methods of controlling a location, such as dragging, by a user, a finger or a writing tool on a touch pad or a touchscreen, using a direction indicator in a keyboard, or, if a remote controller is used, changing a location of a representation image by recognizing a change in a direction of the remote controller, a movement of a pointing point, or the like may be employed.

The storage unit 130 stores a program for driving a function processed by the controller 120, a certain program for implementing convenience of a user and performing various basic functions, or the like. For example, the storage unit 130 is implemented as volatile memory such as RAM or non-volatile memory such as flash memory. The storage unit 130 stores a program for controlling all operations of the symbol image editing apparatus 100, or an operation program for processing data input from the input unit 110. Particularly, the storage unit 130 has letter/numeral code data corresponding to key data or touchscreen data and a symbol image mapped with the letter/numeral code data. The symbol image mapped with the letter/numeral code data is to be described later.

The output section 140 performs a displaying or printing operation under the control of the controller 120.

According to an exemplary embodiment, symbol image information that is output to the output unit 140 is information corresponding to letter/numeral information input via the input unit 110. That is, if a user inputs a letter/numeral to the input unit 110, letter/numeral code data corresponding thereto is extracted, and a symbol image mapped with the letter/code data is output, and thus, displayed on a screen of the output unit 140, or transmitted to the external apparatus, or printed.

According to another exemplary embodiment, letter/numeral information that is output to the output unit 140 is information corresponding to symbol image information input via the input unit 110. In other words, if a user inputs a symbol image to the input unit 110, the symbol image is interpreted, and thus, letter/numeral code data corresponding thereto is extracted. Then, a symbol image mapped with the letter/code data is output, and thus, displayed on a screen of the output unit 140, or transmitted to the external apparatus, or printed.

As described above, a symbol image of Hangul, displayed on a screen of the output unit 140, is represented by using a first space for representing at least one Hangul letter (at least one syllable). Also, the first space is divided into second spaces by using a dot, a line, a surface, or other markings (the second spaces being obtained based on division of the first space) and each of the second spaces may symbolically represent one of an initial consonant, a vowel, and a final consonant, as a representation object such as a triangle, a rectangle, a circle, or a line. Each second space may consist of spaces in a transverse direction, in a longitudinal direction, or in a combination thereof, and each first space may be disposed to be separate from each other in a transverse direction or a longitudinal direction. A representation object may be at least one selected from the group consisting of a triangle, a square, a circle, an object having a shape of a figure, an object configured to have a shape of a figure, and a letter suggesting a shape of a figure.

The controller 120 controls a letter, transmitted from the input unit 110 or another apparatus, to be converted into a symbol image and output via the output unit 140 (output to a screen of the output unit 140, transmitted to the external apparatus, or printed. Alternately, the controller 120 may control a symbol image, transmitted from the input unit 110 or another apparatus, to be converted into a letter and output via the output unit 140.

The controller 120 is configured to include a generation unit 121 and the editing unit 122.

The generation unit 121 generates a symbol image, obtained by inserting a representation image into a location corresponding to a margin position in a letter/numeral image that corresponds to letter or numeral information of a language input via the input unit 110, and display the symbol image on a screen of the output unit 140, transmit the symbol image to the external apparatus, or print the symbol image. The generated symbol image is stored in the storage unit 130.

Additionally, the generation unit 121 may analyze a symbol image, input via the input unit 110, extract in real time a letter/numeral mapped with the symbol image that is input by the user and stored in the storage unit 130, and thus, output a letter/numeral of a language via the output unit 140.

In detail, the generation unit 121 generates a symbol image in a position corresponding to a margin position in an image of a letter corresponding to a Hangul letter, input via the input unit 110. Then, the generation unit 121 divides a rectangular image frame into an initial consonant area and a vowel area as shown in FIGS. 8A and 8B (space division), generates representation images respectively corresponding to an initial consonant and a vowel in an image frame for an initial consonant and an image frame for a vowel. Alternately, the generation unit 121 divides a rectangular image frame into an initial consonant area, a vowel area, and a final consonant area as shown in FIGS. 8C through 8E (space division), generate representation images respectively corresponding to an image frame for an initial consonant, an image frame for a vowel, and an image frame for a final consonant. Then, the generation unit 121 may display a symbol image on a screen of the output unit 140, transmit the symbol image to the external apparatus, or print the symbol image.

Additionally, the generation unit 121 extracts a representation image in the storage unit 130 that is mapped with a letter input by a user, divides a rectangular image frame into an initial consonant area and a vowel area as shown in FIGS. 8A and 8B (space division), and displays representation images, respectively corresponding to an image frame for an initial consonant and an image frame for a vowel, on a screen of the output unit 140, transmit the representation images to the external apparatus, or print the symbol image. Alternately, the generation unit 121 divides a rectangular image frame into an initial consonant area, a vowel area, and a final consonant area as shown in FIGS. 8C through 8E (space division), displays representation images, respectively corresponding to an image frame for an initial consonant image frame, an image frame for a vowel, and an image frame for a final consonant, on a screen of the output unit 140, transmit the representation images to the output unit 140, or print the representation images via the output unit 140.

If a user inputs a symbol image of Hangul, the user selects one from among a rectangular image frames shown in FIGS. 8A and 8B with respect to a letter in which an initial consonant and a vowel of Hangul are combined with each other, or selects one from among rectangular image frames shown in FIGS. 8C through 8E with respect to a letter in which an initial consonant, a vowel, and a final consonant of Hangul are combined with each other. Then, the user designates a part of the rectangular image frame in which a representation object is to be disposed. Then, a process proceeds to an operation in which a user may select a shape of the representation object (a dot, a line, a surface, or the like). If a user selects the “dot”, a process proceeds to an operation in which a shape of the dot (a triangle, a rectangle, a circle, or the like) is to be selected. As such, if a representation object is disposed in a part of a divided space obtained by dividing a space block (for example, a rectangular image frame), the generation unit 121 interprets a symbol image input via the input unit 110, and extracts a letter that is mapped with the symbol image input by the user and stored in the storage unit 130, and output a letter of a language via the output unit 140 in real time.

When symbol images respectively generated according to the principle of generating a symbol image, described above with reference to a letter/numeral, are mapped with each letter/numeral and stored in the storage unit 130, the generation unit 121 may extract in real time a symbol image, which is mapped with a letter/number input by a user and stored in the storage unit 130, and thus, display the symbol image on a screen of the output unit 140, transmit the symbol image to the external apparatus, or print the symbol image.

If a user inputs an edit command of adjusting a size or a location of a symbol image, displayed on a screen of the output unit 140, via the input unit 110, the editing unit 122 edits the symbol image according to the edit command (a function of editing a symbol image in a process of outputting the symbol image). Further, the editing unit edit 122 may freely edit and configure a space block (for example, a rectangular image frame) in which a symbol image is represented, and divided spaces (for example, divided spaces for distinguishing an initial consonant, a vowel, and a final consonant from each other) obtained by dividing the space block (a function of editing a space in a process of inputting/outputting the symbol image).

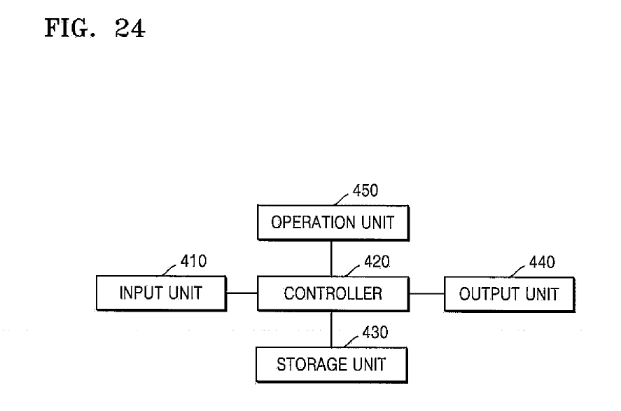

FIG. 24 is a block diagram showing a configuration of a symbol image education apparatus in the present invention.

In the present invention, the symbol image education apparatus includes an input unit 410, a controller 420, a storage unit 430, an output unit 440, and an operation unit 450.

A function of each element is almost similar to that of the symbol image editing apparatus 100 shown in FIG. 1. Thus, a description thereof is provided here briefly.

In the present invention, the symbol image education apparatus is an apparatus for educating a user about a symbol image in an interrogatory form according to an education program set in the symbol image education apparatus.

The symbol image editing apparatus 100 shown in FIG. 1 simply outputs a letter or a symbol image corresponding to a symbol image or a letter that is input. However, the symbol image editing apparatus 100 is different from the symbol image education apparatus in the present invention, in that the symbol image education apparatus outputs a question related to a symbol image to a user, and if the user inputs an answer to the question, the symbol image education apparatus indicates whether the answer is correct.

The education program provided by the symbol image education apparatus may educate users by using various methods, particularly, such as a quiz or a game. A user may use the education program independently or with another user by playing a game to work with the other user.

In detail, the input unit 410 may receive an input of a symbol image or a letter from a user or receive a symbol image or a letter from another apparatus.

A case when the input unit 410 receives an input from a user may include a case when the user inputs an answer to a question, a case when the user plays a game with another user, a case when the user inputs a question to another user, or the like.

As described above, various types of apparatuses such as a keyboard, a key pad, a touchpad, a touchscreen, a camera, or the like may be employed as an input unit 410. A method of inputting a symbol image or a letter is identical to the method performed by the input unit 110, which is described with reference to FIG. 1. Thus, a detailed description thereof will not be provided here.

The output unit 440 displays a symbol image or a letter to the user via a screen or a printer, or transmit to the external apparatus, or print.

Additionally, if a user inputs an answer to a question, the output unit 440 outputs whether the answer is correct.

The output unit 440 outputs a question provided by the education program, outputs a question input by another user if a game provided by the education program is played with the other user, or outputs whether an answer is correct. Additionally, if a game is played by a user together with another user, the output unit 440 transmits information such as a question or the like to a terminal of the other user.

Like the storage unit 130 included in the symbol image editing apparatus 100 shown in FIG. 1, the storage unit 430 stores mapping information between symbol images and letters/numerals and, if a user generates a new symbol image, the storage unit 430 also stores information about the new symbol image.

Additionally, in the present invention, the storage unit 430 may store information about various questions and correct answers used in the education program.

If a user inputs an answer to a question, the operation unit 450 performs an operation with respect to whether the answer is correct.

According to the education program in the present invention, the controller 420 controls the output unit 440 to output a question. If a user inputs an answer to a question via the input unit 410, the controller 420 controls the operation unit 450 to determine whether the answer is correct, and controls the output unit 440 to output a result of whether the answer is correct.

Functions of the generation unit 121 and the editing apparatus 122, shown in FIG. 1, may also be applied to a function of the controller 420 included in the symbol image education apparatus shown in FIG. 24.

A detailed method will be explained again by explaining the method later.

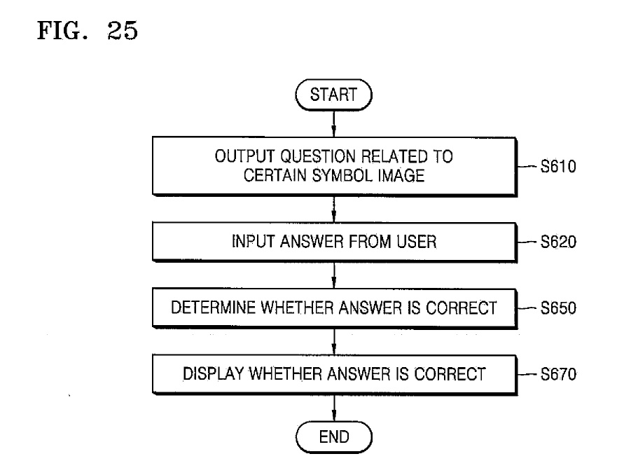

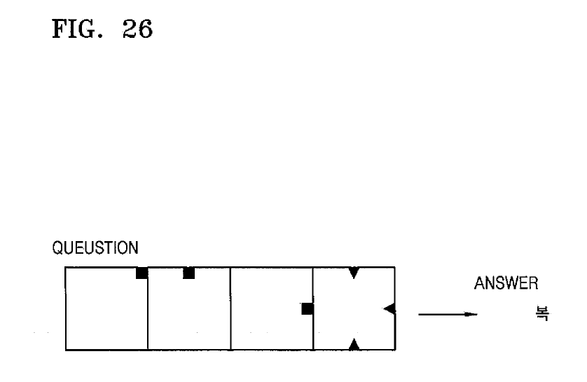

FIG. 25 is a flowchart of a symbol image education method according to an exemplary embodiment of the present invention.

In operation 5610, the controller 420 controls the output unit 440 to output a question related to a certain symbol image.

Various types of questions may be provided to a user according to a type that a user wants.

As an example, if the user plays a game independently, the controller 420 may select a question from among questions stored in the storage unit 430 arbitrarily or according to a determined order of questions, and then, output the question to the user.

In this case, the question may be output by using a method of simply outputting a letter so that the user inputs a symbol image corresponding to the letter, or a method of outputting a symbol image and receiving a letter as an answer from a user.

Additionally, a question and an answer may be formed of different languages. For example, as shown in FIG. 25, [symbol] in Korean is presented as a question, and a user may input a symbol image of an English word, ‘LUCK’ as an answer to the question.

As another example, as shown in FIGS. 13A through 13D, 14A through 14C, 15, and 16A through 16C, a plurality of symbol images overlap with each other, and a user may input an answer by using letters corresponding to the plurality of symbol images.

As another example, a certain letter or symbol image may be output as a question, and then, a user may implement a symbol image corresponding thereto in a space.

As shown in FIGS. 20 through 23, a user may answer a question by representing a representation image and a location of the representation image in a space by using an object or a shape of a hand. Conversely, an image in which an object is implemented in a space is shown, and then, a user may answer a symbol image or a letter corresponding to the image of the object.

As another example, representation images of a symbol image may be consecutively output by intervals, instead of being output at a same time. Then, a user may answer a letter or symbol image corresponding to the representation images based on inference from the output representation images.

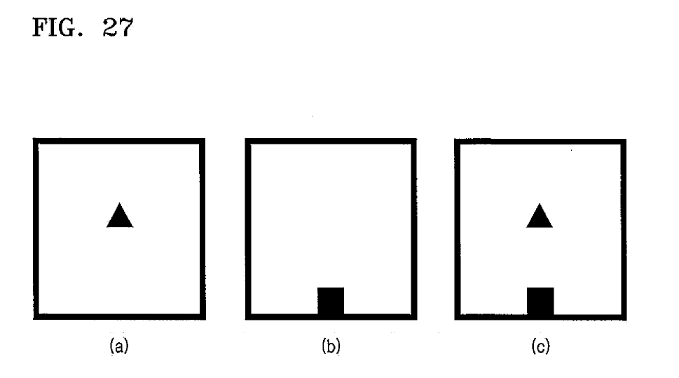

For example, as shown in FIGS. 27A through 27C, if images are output to a screen in an order from an image in FIG. 27A to an image in FIG. 27B, if both of the images are combined with each other, a symbol image indicating ‘A’ is obtained as shown in FIG. 27C. A user may be required to answer a question only based on the images shown in FIGS. 27A and 27B.

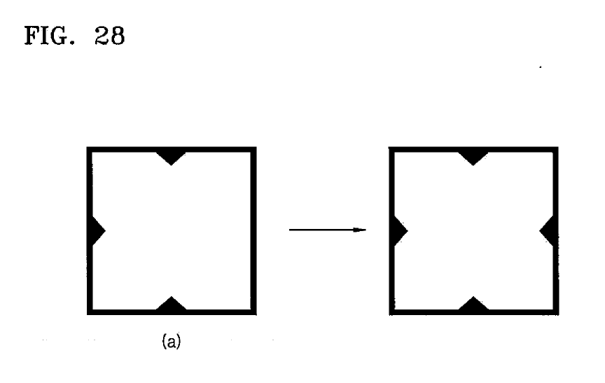

As another example, as shown in FIG. 28, a part of a symbol image may not be shown, and a user may find out a symbol image whose part is not shown.

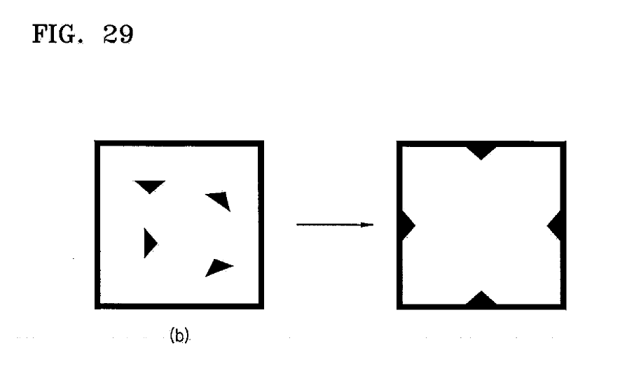

As another example, as shown in FIG. 29, a symbol image may be located in an incorrect position, and then, a user may locate the symbol image in a correct position to complete a symbol image.

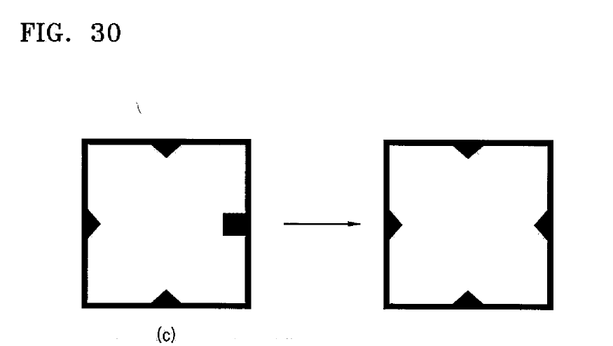

As another example, as shown in FIG. 30, a part of a shape of a symbol image may be changed, and a user may correct the shape of the symbol image.

A plurality of users may play a game together, such that a party of the plurality of users may provide a question, and the other part may answer the question.

In this case, the party may provide a question by using a method from among the methods described above.

As another method, users may play Shiritori. If a user inputs a word to play Shiritori, a symbol image of the word is output to a terminal of another user. Then, the other user, who received the symbol image of the word, may input a symbol image or a letter of another word whose first syllable is identical to a final syllable of the word input by the user.

If a question is output via the controller 420 by using various methods as described above, a user may input a symbol image or a letter corresponding to the question via the input unit 410 in operation 5620.

As described above, various methods of inputting an answer to the input unit 410, such as a method of inputting an answer by using a keyboard, a touchpad, a touchscreen, or the like, a method of inputting an answer by using a camera, or the like, may be employed.

As such, if the user inputs an answer, the operation unit 450 determines whether the answer is correct in operation 5650.

A method of determining whether the answer is correct includes extracting a correct answer and determining whether the correct answer matches the answer input by the user if the correct answer is stored together with the question in the storage unit 430, or generating a letter or a symbol image corresponding to a correct answer by using a generation unit (not shown) included in the controller 420 and comparing the generated letter or symbol image to the answer input by the user if a correct answer is not stored in the storage unit 430.

If it is determined by the operation unit 450 whether the answer is correct, the controller 420 controls the output unit 440 to output information about whether the answer is correct in operation 5670.

If it is determined that the user gave a correct answer, a learning game using letter information with a next level of difficulty may be played. If it is determined that the user did not give a correct answer, the controller 420 may control the output unit 440 to show that the user's mission has failed, and control a learning game using an image that has a lower level of difficulty than that of a previous game, or a learning game using an image that has a same level of difficulty as that of a previous game and consists of different questions from that of the previous game to be played.

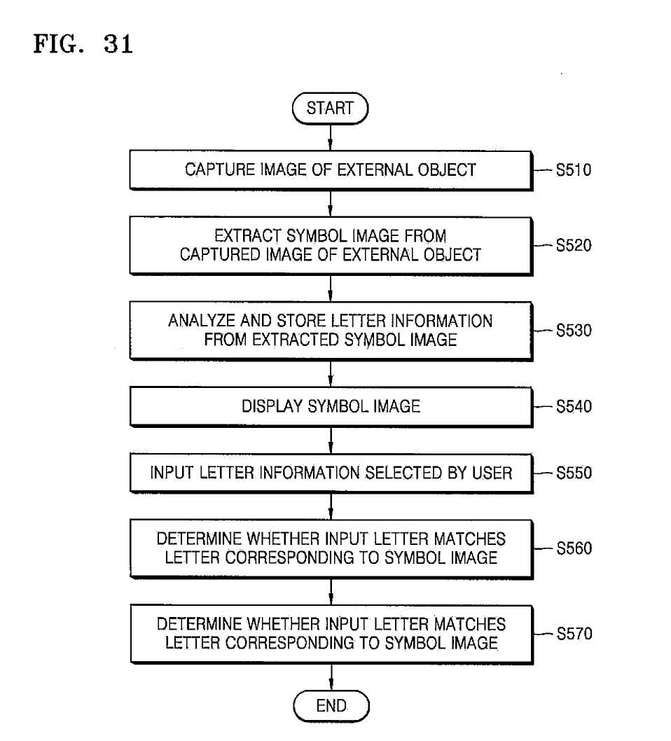

FIG. 31 is a flowchart showing a method according to another embodiment of the present invention.

In operation 5510, a user captures an image of a design object in which a symbol image is implemented, by using a photographing function of the input unit 410 included in the symbol image education apparatus, to obtain the captured image of the design object.

The captured image of the design object is stored in the storage unit 430. The operation unit 450 extracts a symbol image from the captured image stored in the storage unit 430 in operation 5520, and analyzes letter information corresponding to the extracted symbol image based on the extracted symbol image in operation 5530. The symbol image extracted by the operation unit 450 and the letter information analyzed by the operation unit 450 are stored in the storage unit 430.

In practicing the present invention, an infrared camera for obtaining information about a temperature emitted from an external design object to the input unit 410 may be employed. A heat image of the external design object, captured by the infrared camera, is stored in the storage unit 430. In operation S520, the operation unit 450 extracts a symbol image from the heat image of the external design object stored in the storage unit 430. In operation S530, the operation unit 450 may analyze letter information corresponding to the extracted symbol image from the extract symbol image.

As such, the symbol image education apparatus may perform operation 5530 by obtaining external information about an external design object, in which a symbol image is represented, from the external design object by using various methods such as using an image, a heat image, a frequency, a temperature, infrared light, ultraviolet light, or the like. For this, the symbol image education apparatus may include a separate detection module (for example, an infrared detection module, an ultraviolet detection module, a thermal detection module, a signal detection module, a frequency detection module, or the like) for recognizing symbol image information shown in the external design object as an invisible element.

The operation unit 450 may extract a symbol image from image information that is external image information about a design object, by employing a method of selecting a symbol image that most highly matches information about a captured image of the design object by performing a pattern search method of comparing various symbol images pre-stored in the storage unit 430 to information about the captured image of the design object one by one.

Additionally, the operation unit 450 may extract and analyze letter information corresponding to the extracted symbol image, by inversely applying an operation of generating a symbol image of a letter, which is described with reference to FIG. 2, to the extracting of the symbol image from the letter information.

In operation 5540, the symbol image, extracted in operation S530 described above, is provided to the user via the output unit 440 as a question for educating the user. Additionally, in practicing the present invention, the symbol image, provided to the user as a question via the output unit 440 in operation 5540, may be a symbol image directly extracted from the design object as described with reference to operations S510 through step 5530. However, the symbol image may be a symbol image arbitrarily selected from a plurality of symbol images pre-stored in the storage unit 430.

The user infers letter information from a symbol image provided via the output unit 440 in operation S540 described above and, accordingly, selects and inputs letter information to the input unit 410 in operation 5550.

Accordingly, in operation 5560, the operation unit 450 included in the symbol image education apparatus determines whether the letter information, input by the user to the input unit 410, matches letter information corresponding to the symbol image shown in the output unit 440. If the letter information input by the user matches the letter information corresponding to the symbol image, the output unit 440 shows that a mission provided to the user is complete in operation 5570 to proceed to a learning game using a symbol image having a next level of difficulty.

If it is determined that the letter information, input by the user to the input unit 410, does not match the letter information corresponding to the symbol image shown on the output unit 440, the operation unit 450 indicates that a mission provided to the user has failed via the output unit 440 in operation 5570, and proceeds to a learning game using an image with a low level of difficulty or a learning game using an image that has a same level of difficulty as a previous learning game and consists of questions different from those of the previous learning game.

The present invention can also be embodied as computer-readable codes on a computer-readable recording medium. The computer-readable recording medium is any data storage device that can store data which can be thereafter read by a computer system. Examples of the computer-readable recording medium include read-only memory (ROM), RAM, CD-ROMs, magnetic tapes, floppy disks, and optical data storage devices. The computer-readable recording medium can also be distributed over network coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the inventive concept as defined by the following claims.

1. A symbol image education method comprising:
outputting, by a symbol image education apparatus, a question related to a symbol image corresponding to a letter;
receiving, by the symbol image education apparatus, an input of an answer to the output question from a user;
determining, by the symbol image education apparatus, whether the answer, input from the user, is a correct answer to the output question; and
outputting, by the symbol image education apparatus, whether the answer input from the user is correct,
wherein the symbol image is formed by at least one representation image having a predetermined shape in a location corresponding to a margin position of an image of the letter.

2. The symbol image education method of claim 1, wherein, with respect to the question, the symbol image is output and a letter corresponding to the output symbol image is required.

3. The symbol image education method of claim 1, wherein, with respect to the question, the letter is output and a symbol image corresponding to the output letter is required to be input.

4. The symbol image education method of claim 3, wherein, with respect to the question, the symbol image having an inaccurate form is output, and an accurate form of the output symbol image is required.

5. The symbol image education method of claim 1, wherein the representation image comprises an image of a dot having a certain shape.

6. The symbol image education method of claim 2, wherein the symbol image comprises symbol images that correspond to a plurality of letters and overlap with each other in a space.

7. The symbol image education method of claim 2, wherein, with respect to the symbol image, representation images of the symbol image are not output to a screen at the same time, and screens in which a part of the representation images is output are sequentially output.

8. The symbol image education method of claim 1, wherein the output question is transmitted from a terminal of another user.

9. A symbol image education apparatus comprising:
an output unit configured to output a question related to a symbol image corresponding to a letter;
an input unit configured to receive an input of an answer to the output question from a user;
an operation unit configured to determine whether the answer, input from the user, is a correct answer to the output question; and
a controller configured to output the question, determine whether the answer is correct if the answer by the user is input, and output a result of the determination as to whether the answer is correct,
wherein the symbol image is formed by at least one representation image having a predetermined shape in a location corresponding to a margin position of an image of the letter.

10. The symbol image education apparatus of claim 9, wherein, with respect to the question, the symbol image is output and a letter corresponding to the output symbol image is required.

11. The symbol image education apparatus of claim 9, wherein, with respect to the question, the letter is output and a symbol image corresponding to the output letter is required to be input.

12. The symbol image education apparatus of claim 11, wherein, with respect to the question, the symbol image having an inaccurate form is output, and an accurate form of the output symbol image is required.

13. The symbol image education apparatus of claim 9, wherein the representation image comprises an image of a dot having a certain shape.

14. The symbol image education apparatus of claim 10, wherein the symbol image comprises symbol images that correspond to a plurality of letters and overlap with each other in a space.

15. The symbol image education apparatus of claim 10, wherein, with respect to the symbol image, representation images of the symbol image are not output to a screen at a same time, and screens in which a part of the representation images is output are sequentially output.

16. The symbol image education apparatus of claim 9, wherein the output question is transmitted from a terminal of another user.

17. The symbol image education apparatus of claim 9, further comprising a storage unit configured to store information about the question and a correct answer to the question.

18. A non-transitory computer-readable recording storage medium having recorded thereon a computer program which, when executed by a computer, performs the method of claim 1.
